(19) United States
(12) Patent Application Publication
(10) Pub. No.: US 2005/0201340 A1
(43) Pub. Date: Sep. 15, 2005

(54) Distributed TDMA for wireless mesh network

(76) Inventors: Xudong Wang, Jixi (CN); Weilin Wang, San Diego, CA (US); Michael P. Nova, Del Mar, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/076,738

(22) Filed: Mar. 9, 2005

Related U.S. Application Data
(63) Continuation-in-part of application No. 10/816,481, filed on Apr. 1, 2004.
Application No. 10/816,481 is a continuation-in-part of application No. 10/437,128, filed on May 13, 2003.
Application No. 10/816,481 is a continuation-in-part of application No. 10/437,129, filed on May 13, 2003.
(60) Provisional application No. 60/380,425, filed on May 13, 2002.

(51) Int. Cl. H04J 3/00; H04B 7/212; H04Q 7/24

(52) U.S. Cl. 370/337; 370/347

(57) ABSTRACT

Systems and methods are provided that facilitate distributed TDMA communication amongst nodes in an ad hoc wireless network without the need for centralized management and control. A wireless communication device includes a MAC layer that is configured to synchronize its local clock from a beacon frame that is sent by another node in the ad hoc network. After synchronizing its clock to the ad hoc network, the device identifies a timeslot for transmission. When the timeslot arrives, the device senses the channel to determine if there is traffic and if there is no traffic, the device reserves the timeslot by transmitting. In this fashion, a plurality of timeslots can be divided amongst the devices in the ad hoc wireless network for optimized collision free communication using distributed TDMA. This distributed TDMA communication can also be applied across multiple channels in a wireless network to significantly increase bandwidth and quality-of-service.

### RELATED APPLICATION

The present application is a continuation-in-part of U.S. patent application Ser. No. 10/816,481 filed on Apr. 1, 2004, which is a continuation-in-part of U.S. patent application Ser. Nos. 10/437,128 and 10/437,129 filed on May 13, 2003 that each claim the benefit of provisional application 60/380,425 filed on May 13, 2002, all of which are incorporated herein by reference in their entirety.

### BACKGROUND

1. Field of the Invention

The present invention generally relates to wireless communication networks and more specifically relates to a media access control (“MAC”) layer protocol design and implementation of a distributed time division multiple access (“TDMA”) protocol for wireless mesh networks, over different types of physical layers.

2. Related Art

TDMA is a digital transmission technology that allows a number of users to access a single radio-frequency (“RF”) channel without interference by allocating unique time slots to each user within each channel. TDMA requires a centralized controller that broadcasts a timing beacon for wireless devices to synchronize with and assigns time slots to the various wireless devices in the network.

For example, FIG. 1 is a network diagram of a prior art wireless network with a central controller 10 for managing TDMA communications. In the illustrated embodiment, the central controller 10 is in wireless communication with network devices 20, 30, and 40. The controller 10 is configured to manage TDMA communications by sending out a beacon signal to which all devices synchronize their local clocks. The controller 10 additionally assigns timeslots to each device during which the device can transmit packets over the network. The controller 10 is typically configured as part of a stationary base station or wireless access point and controls all of the wireless devices within its geographical transmission range. Accordingly, TDMA is inherently flawed for implementation in a wireless ad hoc or mesh network environment where there is no centralized controller to assign time slots and broadcast a timing beacon.

TDMA additionally suffers from wasted bandwidth. In some TDMA systems such as the global system for mobile communications (“GSM”), the central controller assigns each wireless device one or more time slots for transmission and if a particular device has no pending data to transmit, the time slot will go unused. In aggregate, unused slots can be very burdensome on a TDMA communication system, in particular a communication system adapted for data communications. In some TDMA systems such as the general packet radio service (“GPRS”) or the third generation of mobile phone technologies covered by the ITU IMT-2000 family (“3G”) cellular networks, dynamic time slot allocation is allowed. However, this has to be performed by a central controller, e.g., base station. In order to send the dynamic information, e.g., queue length, traffic load, etc., of network nodes to the central controller, frequent message exchange is needed between network nodes and the central controller, which causes a high signaling overhead.

Furthermore, none of the standard IEEE 802.11, IEEE 802.16 or Ultra-Wide Band (“UWB”) MAC protocols are well suited for multi-hop wireless ad hoc networking environments such as that found in a wireless mesh network. For IEEE 802.16 mesh networks, a central controller is still needed. For IEEE 802.11, the dependence of the MAC standard on the carrier sense multiple access with collision avoidance (“CSMA/CA”) protocol creates significant problems when deployed in a wireless mesh network setting. In particular, because of hidden and exposed nodes, the throughput and quality of service (“QoS”) of the network degrade significantly as the network size increases. Thus, the MAC standard is not scalable in a wireless mesh network environment. For example, because wireless communication devices typically have a sensing range that is more than double that of the communication range in order to resolve the hidden node issue, there is significant waste of communication bandwidth when a device holds a transmission due to the sensing of a communication that is out of communication range.

A recent enhancement to IEEE 802.11 MAC, called IEEE 802.11e, is being standardized to improve QoS provisioning in wireless local area networks (“WLANs”). Similarly to the standard MAC, it can be applied to a wireless ad hoc or mesh network. However, it still lacks scalability in a multi-hop environment, mainly because a central controller, called QoS-enabled access point (“QAP”), is needed to setup peer-to-peer communications and allocate and reserve collision free periods (“CFPs”) for network nodes.

In addition, a conventional MAC architecture requires a new design in software, firmware, and hardware, which further needs re-design of MAC chipsets, making new MAC design complicated and costly. Therefore, a better architecture for designing and implementing a new MAC is a MAC platform with software-radio-enabled chipsets. Although a few MAC chipset with software defined radio (“SDR”) capability are available, they lack the ability to perform cross-layer design between MAC and physical layer to meet the requirements of wireless ad hoc or mesh networks. For example, currently, most MAC drivers utilize the SDR capability to do link adaptation by performing adaptive modulation, coding, and antenna selection according to the variable link quality. However, no system or method is available to take advantage of the SDR capability to design a scalable multiple access scheme for wireless mesh networks.

Therefore, what is needed is a system and method that overcomes these significant problems found in the conventional systems as described above.

### SUMMARY

Accordingly, systems and methods are provided to allow for the implementation of distributed TDMA communication technology in a wireless ad hoc network. The systems and methods provide for distributed TDMA communication amongst the nodes in a wireless ad hoc or mesh network without the need for centralized management and control. A wireless communication device includes a MAC layer that is configured to synchronize its local clock from a beacon frame that is received from another node in the same network. After synchronizing its clock to another node, the device identifies a time slot for transmission. When the time slot arrives, the device senses the channel to determine whether or not there is traffic. If there is no traffic, the device reserves the channel by transmitting a packet. In this fashion, a plurality of timeslots can be self allocated amongst the devices in the ad hoc wireless network for optimized collision free communication using distributed TDMA. This distributed TDMA communication can also be applied across multiple channels in a wireless network to significantly increase bandwidth and quality-of-service (“QOS”). A device may reserve more timeslots when necessary and the MAC layer is configured to release timeslots that are not needed.

The distributed TDMA MAC can be implemented as a software driver to dynamically re-program the hardware in the SDR chipsets, according to the logic of the MAC protocol. Where re-design of chipsets is preferred, the distributed TDMA MAC can be implemented as firmware and/or hardware.

Additionally provided is a network management method for self organization in a wireless ad hoc or mesh network that optimizes bandwidth usage by nodes in a wireless network. The nodes in the wireless network self organize into various fully connected mesh (“FCM”) networks. The self organization process propagates topology information about networks nodes throughout the wireless network and allows a node to determine the number of hops between itself and another node in the wireless network. Thus, although a first node senses the transmission from a second node (sent to a third node), the first node can send its own transmission to a fourth node that is out of range to receive the second node's transmission. This directional carrier sense drastically eliminates the exposed node problem in wireless communication networks.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram of a prior art wireless network with a central controller for managing TDMA communications;

FIG. 2A is a high level network diagram of an example decentralized wireless communication network for distributed TDMA communications according to an embodiment of the present invention;

FIG. 2B is a block diagram illustrating an example wireless communication device according to an embodiment of the present invention;

FIG. 3 is a flow diagram illustrating an example segment of distributed TDMA over time according to an embodiment of the present invention;

FIG. 4 is a flow diagram illustrating an example process for the flow of data packets being transmitted in distributed TDMA communication according to an embodiment of the present invention;

FIG. 5 is a flow diagram illustrating an example process for data communication during a distributed TDMA window of a beacon interval according to an embodiment of the present invention;

FIG. 6 is a flow diagram illustrating an example process for managing a transmission queue according to an embodiment of the present invention;

FIG. 7 is a flow diagram illustrating an example process for acquiring more transmission timeslots according to an embodiment of the present invention;

FIG. 8 is a flow diagram illustrating an example process for distributed TDMA communication control according to an embodiment of the present invention;

FIG. 9 is a flow diagram illustrating an example process for synchronizing a local clock for distributed TDMA communication according to an embodiment of the present invention;

FIGS. 10A-D are network diagrams illustrating example self organizations of nodes in a wireless network according to an embodiment of the present invention;

FIG. 11 is a network diagram illustrating example directional carrier sense communication in a wireless network according to an embodiment of the present invention;

FIG. 12 is a block diagram illustrating an exemplary wireless communication device that may be used in connection with the various embodiments described herein; and

FIG. 13 is a block diagram illustrating an exemplary computer system that may be used in connection with the various embodiments described herein.

### DETAILED DESCRIPTION

Certain embodiments disclosed herein provide for systems and methods for distributed TDMA communication between nodes of a wireless communication network. For example, one system as disclosed herein provides an enhanced MAC layer on a network device that is configured to join an FCM network in a wireless network and use distributed TDMA for communications. Additionally, one method as disclosed herein provides for a wireless device configured with an enhanced MAC to receive a beacon signal from a node in a wireless communication network and synchronize a local clock based on a timestamp in the beacon. The synchronized device then identifies one or more timeslots on one or more communication channels and uses the one or more timeslots to transmit. The synchronized device may also employ a routine to optimize the number of timeslots it reserves for transmitting based on its transmission buffer.

After reading this description it will become apparent to one skilled in the art how to implement the invention in various alternative embodiments and alternative applications. To facilitate a direct explanation of the invention, the present description will focus on an embodiment where communication is carried out over a single channel, although the invention may be applied in a multi-channel embodiment as well. For example, a single transceiver radio system time-multiplexes over a number of channels, or a multi-transceiver radio system operates concurrently on a number of independent channels, each adhering to a uniform or channel-specific time-slot allocation and scheduling algorithm. Therefore, it should be understood that the single channel embodiment is presented by way of example only, and not limitation. As such, this detailed description should not be construed to limit the scope or breadth of the present invention as set forth in the appended claims.

FIG. 2A is a high level network diagram of an example decentralized wireless communication network 90 for distributed TDMA communications according to an embodiment of the present invention. In the illustrated embodiment, the network 90 comprises wireless communication devices 50, 60, 70, and 80. The network 90 has no central controller for wireless devices 50, 60, 70, and 80 (although a controller for other network devices/purposes may be present) and each of the devices is in wireless communication with one or more other devices in the network. The decentralized wireless communication network 90 may also be referred to herein as an ad hoc network or a mesh network.

The network 90 can be a wired network, a wireless network, or a combination of homogeneous or heterogeneous networks including both wired and wireless. Network 90 can be a personal area network (“PAN”), local area network (“LAN”), wide area network (“WAN”), or a distributed combination of networks collectively comprising a global communications network such as the Internet. Network 90 can be an ad hoc network or a persistent network and can be fixed in location, mobile, or network 90 may comprise a combination of fixed and mobile components. Additionally, network 90 may carry communications corresponding to a single network protocol or to multiple network protocols. For example, network 90 may carry 802.3 Ethernet traffic and 802.11 wireless traffic.

In this detailed description, a wireless communication device such as device 50 may also be referred to as a network device, device, network node, node, wireless device, or wireless node. Although various names may be used herein, a wireless device may comprise all or a minimal subset of the components and functional capabilities described with respect to FIGS. 2B, 12 and 13.

In one embodiment, wireless device 50 can be a sensor device with the ability to send and receive communications over a wired or wireless communication network. Alternatively, the device 50 can be a gaming device or an input device for a gaming station or other type of base unit such as a computer or computer controlled device. Wireless device 50 can also be a laptop computer, cell phone, personal digital assistant (“PDA”), game console, wireless TV set and set-top box, radio frequency identification (RFID) reader, or any of a variety of stationary or mobile devices to which communication is desirable.

FIG. 2B is a block diagram illustrating an example wireless communication device 50 according to an embodiment of the present invention. In the illustrated embodiment, the device 50 comprises a MAC layer 100 that itself comprises a control module 105 and a distributed TDMA module 110.

In the illustrated embodiment, the MAC layer 100 is a module that can advantageously be part of a suite of communication utilities that includes the ability to send communication packets over the physical network medium, whether the medium is wired or wireless. For example, a physical layer (not pictured) can be a module that facilitates that direct transmission of packets onto and reception of packets from the network medium. Additionally, the suite of communication utilities may also include network layers that advantageously provide for network level addressing and interfaces with applications that run on the device 50. The MAC layer 100 may also include interfaces with applications that run on the device 50. The MAC layer 100 may be implemented in software, hardware, or as a combination of hardware and software.

In the illustrated embodiment, the control module 105 implements device management functions such as beacon generation, beacon transmission, beacon reception, and time synchronization. Additionally, control module 105 implements network management functions such as self organization, distributed timeslot allocation and power management.

The distributed TDMA module 110 in the illustrated embodiment is configured to send and receive data according to the timeslot reservations during data communications. The TDMA module 110 can also be configured to communicate with the physical layer (or physical network medium), the network layer, or individual applications. The TDMA module 110 can be configured to implement a hybrid carrier sense TDMA communication scheme that facilitates high bandwidth communications in a wireless communication network with optimally low collisions.

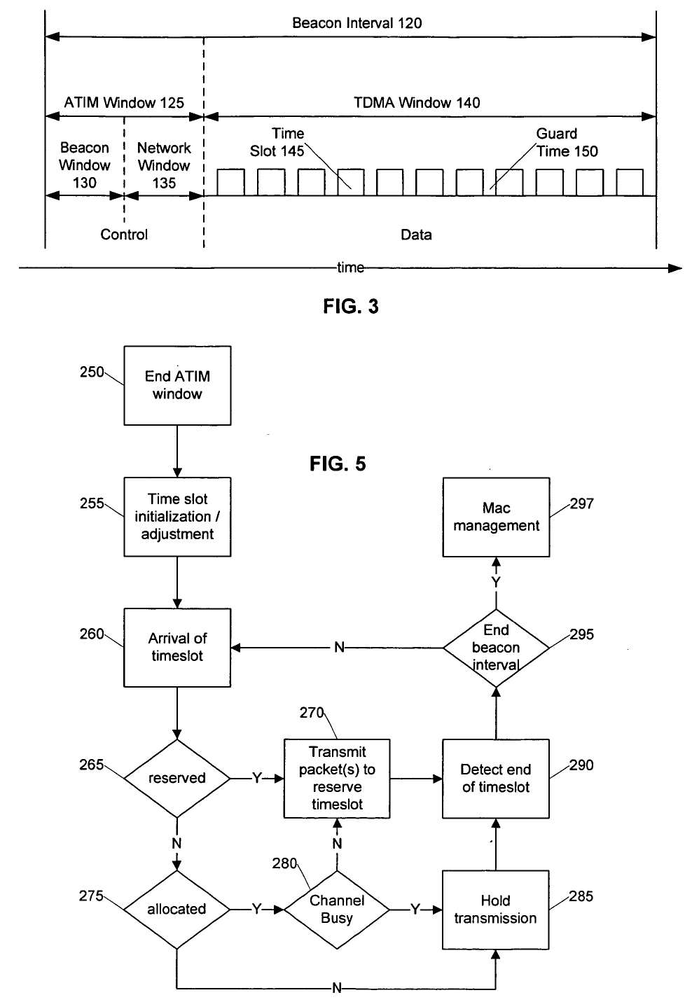

FIG. 3 is a flow diagram illustrating an example segment of distributed TDMA communication over time, according to an embodiment of the present invention. The described distributed TDMA communication may be carried out by a device such as the wireless communication device previously described with respect to FIGS. 2A and 2B. In the illustrated embodiment, a single beacon interval 120 is shown. The beacon interval 120 comprises an announcement traffic indication map (“ATIM”) window 125 and a distributed TDMA window 140. The TDMA window 140 may also be referred to as a TDMA frame, although a TDMA frame is not to be confused with a frame of data. The TDMA window 140 is a time segment during which various nodes in the network both send and receive data.

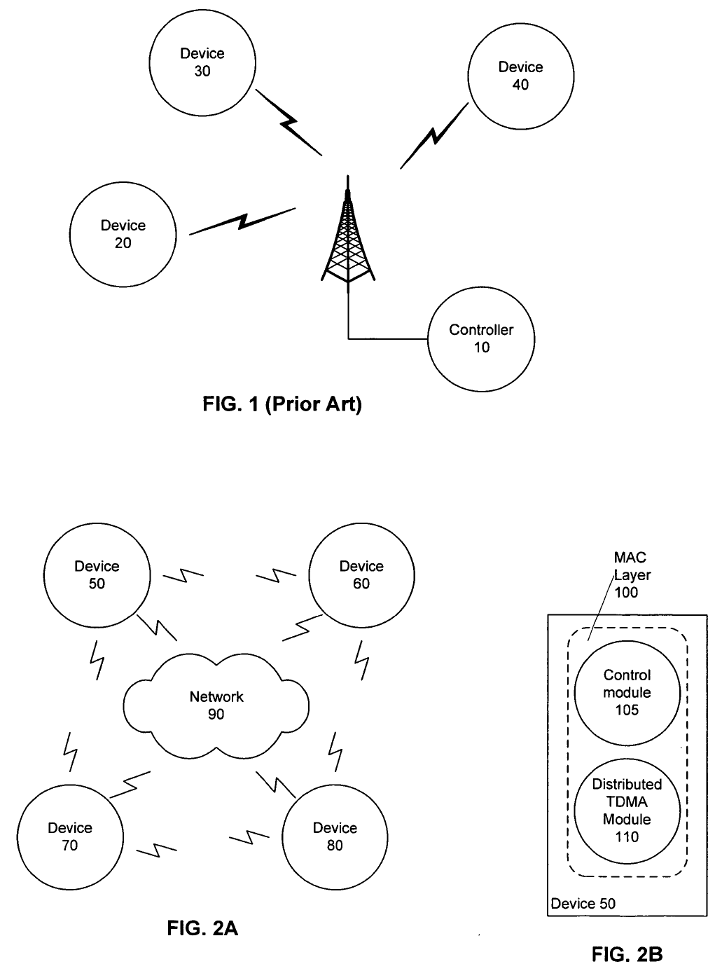

In the illustrated embodiment, the ATIM window 125 is the time segment during which control operations are performed. For example, the previously described device and network management functions are carried out during the ATIM window, for example, by the control module 105 previously described with respect to FIG. 1. This is the control portion of the beacon interval 120. The ATIM window is divided into a beacon window 130 and a network window 135.

The beacon window 130 is the time segment during which beacon management functions are performed. For example, beacon generation, beacon transmission, beacon reception, and time synchronization can be performed during the beacon window 130. In one embodiment the time synchronization can be carried out by executing the 802.11 standard time synchronization function (“TSF”) or other existing schemes. The network window 135 is the time segment during which power management and network self organization tasks are performed. For example, distributed timeslot allocation may take place during the network window 135. During distributed timeslot allocation, the nodes in the network can determine how many timeslots 145 there are in the distributed TDMA window 140 and the size of the guard time 150. Distributed timeslot allocation may also take place at the end of the ATIM window 125, although before commencement of data transmissions during the TDMA window 140.

In the illustrated embodiment, the TDMA window 140 comprises a plurality of timeslots 145 that are separated by a plurality of guard times 150. In order to maximize bandwidth utilization in a network, it is desirable to maximize the overall size of timeslots 145 and minimize the size of guard times 150. Alternatively, throughput can be maximized by minimizing the number of guard times 150 and in combination maximizing the size of the timeslots 145.

In one embodiment the size or length of a timeslot 145 can be determined by the maximum transmission unit (“MTU”) of a MAC packet. Accordingly, when the size or length of the TDMA window 140 is known, then the number of timeslots 145 can be determined based a minimum size of the guard time 150. Alternatively, the number of timeslots 145 can be determined according to the optimum number of neighbor nodes in the wireless network and then the size of a timeslot 145 can be determined by size of the TDMA window 140 and the minimum size of the guard time 150. Thus, in one embodiment, the size of the timeslot 145 is determined and then the number of timeslots 145 is derived and in an alternative embodiment, the number of timeslots 145 is determined and then the size of a timeslot 145 is derived.

Although not shown in the illustrated embodiment, additional beacon intervals precede and follow the beacon interval 120 shown in the figure. Accordingly, the wireless communications comprise repeated control communications followed by data communications. In this fashion, distributed TDMA may be implemented in an ad hoc or mesh network.

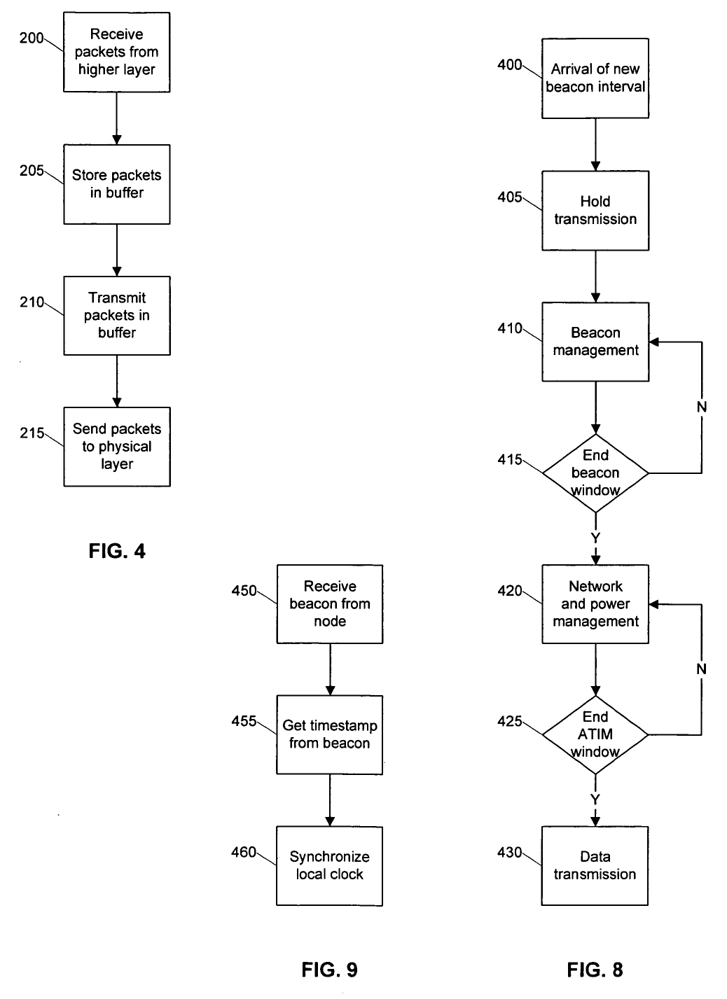

FIG. 4 is a flow diagram illustrating an example process for the flow of data packets being transmitted in distributed TDMA communication according to an embodiment of the present invention. The example process may be carried out by a device such as the wireless communication device previously described with respect to FIGS. 2A and 2B. In the illustrated embodiment, the process initially begins at step 200 with the MAC layer receiving data packets from a higher layer, e.g., logical link layer or network layer.

After the packets have been received, the MAC layer stores the packets in a transmission buffer, as shown in step 205. Upon the arrival of a transmission timeslot, in step 210 the MAC layer transmits the packets in the buffer and causes the packets to be sent to the physical layer, as illustrated in step 215.

FIG. 5 is a flow diagram illustrating an example process for data communication during a distributed TDMA window of a beacon interval according to an embodiment of the present invention. The example process may be carried out by a device such as the wireless communication device previously described with respect to FIGS. 2A and 2B. In the illustrated embodiment, the process begins at step 250 with the close of the ATIM window. Next, in step 255, timeslot management occurs, including initialization and adjustment of timeslots. If the node has newly joined the network, the node performs an initial allocation of timeslots. In one embodiment, the initial allocation process comprises the node allocating itself a random number of time slots. The node may also allocate a predetermined number of timeslots based on the size of the transmission buffer or some other metric.

If the node has previously joined the network, then the node performs timeslot adjustment to determine whether it needs more timeslots to transmit, needs less timeslots to transmit, or has the optimal number of timeslots to transmit. During timeslot adjustment, the determination of whether the node needs more or less timeslots can be made from the current size of the transmission buffer in combination with historical information about the size of the transmission buffer. In a simple example, if the buffer is growing, then more timeslots are allocated; if the buffer is shrinking timeslots are released; if the buffer is empty, then all (or substantially all) timeslots are released; and if the buffer is the same size, then no timeslots are allocated and no timeslots are released.

In one embodiment, timeslots can be released immediately while timeslots that are allocated by a node during timeslot adjustment or timeslot initialization are not reserved until the arrival of the timeslot and after a carrier sense operation determines that the timeslot is available. Timeslots are reserved by transmitting one or more packets during the timeslot.

When the next timeslot arrives in the TDMA frame, as detected by the node in step 260, the node determines if the timeslot is reserved in step 265. If the timeslot is reserved, then the node transmits packets, as shown in step 270. If the timeslot is not reserved, then the node determines in step 275 whether it has allocated the timeslot. If the node has allocated the timeslot, then the node performs a carrier sense operation on the channel to determine if the channel is busy, as illustrated in step 280. If the channel is not busy, the node proceeds to step 270 and transmits one or more packets on the channel to reserve the channel. If the channel is busy, as determined in step 280, then the node holds its transmission as shown in step 285 and goes into receive mode to receive the packets being transmitted if they are directed to the node's MAC address. Going back to step 275, if the node determines that it has not allocated the timeslot, then the node holds its transmission as shown in step 285 and goes into receive mode to receive the packets being transmitted if they are directed to the node's MAC address.

Whether the node holds its transmission or transmits packets, in step 290, the node detects the end of the timeslot. Next, in step 295, the node determines whether the end of a beacon interval has arrived. If the end of the beacon interval has not arrived, the node returns to step 260 for the arrival of the next timeslot. If the end of a beacon interval has arrived, then the node moves on to the ATIM window of the next beacon interval to carry out necessary control functions to manage distributed TDMA communications, as show in step 297.

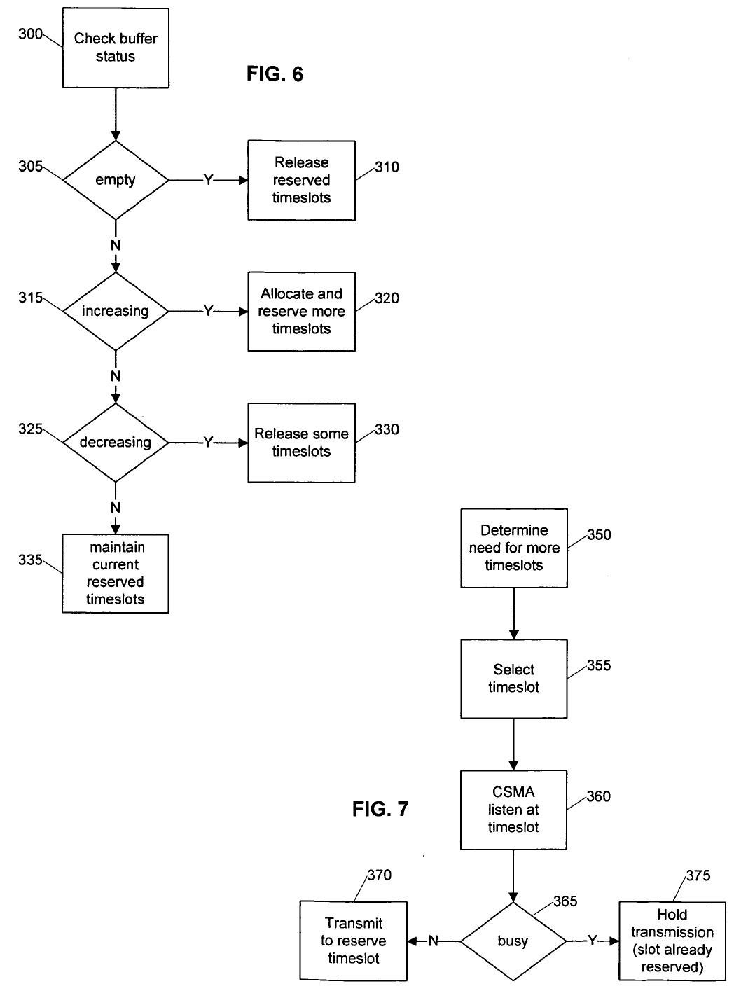

FIG. 6 is a flow diagram illustrating an example process for managing a transmission queue according to an embodiment of the present invention. The example process may be carried out by a device such as the wireless communication device previously described with respect to FIGS. 2A and 2B during implementation of timeslot adjustment as previously described in step 255 of FIG. 5. In the illustrated embodiment, the node initially checks its transmission buffer in step 300. If the buffer is empty, as determined in step 305, the node then releases all of its reserved timeslots, as shown in step 310.

If the buffer is not empty, in step 315 the node determines if the size of the buffer is increasing. For example, this determination may be made from an analysis of historical data about the size of the buffer. If the size of the buffer is increasing, then the node allocates more timeslots in step 320. The allocated timeslots are reserved as they arrive and after a carrier sense operation is performed to determine whether the channel is or is not busy during the timeslot. If the channel is not busy, then the timeslot can be reserved by transmitting data during the timeslot.

If the buffer is not increasing, as determined in step 315, the node then determines if the size of the buffer is decreasing, as shown in step 325. This determination, for example, may also be made from an analysis of historical data about the size of the buffer. If the size of the buffer is decreasing, then in step 330 the node can release a portion of the timeslots it has reserved.

Advantageously, when a node releases a timeslot, no affirmative action is required. The node may simply not transmit data when the released timeslot next arrives. Due to the distributed nature of the TDMA timeslot reservation, each timeslot can be dynamically released or reserved during each beacon interval. Advantageously, this allows a node with lots of data to reserve as many timeslots as are available in order to achieve a high bandwidth burst transmission and then later release those timeslots for reservation and transmission by other nodes in the network.

If the size of the transmission buffer is not decreasing, as determined in step 325, then the size of the buffer is remaining steady and the node can maintain the current number of reserved timeslots for transmission, as shown in step 335.

FIG. 7 is a flow diagram illustrating an example process for acquiring more transmission timeslots according to an embodiment of the present invention. The example process may be carried out by a device such as the wireless communication device previously described with respect to FIGS. 2A and 2B during reservation of additional timeslots. In the illustrated embodiment, the node initially determines the need for additional transmission timeslots in step 350. Next, the node allocates additional timeslots in step 355 based on the timeslot allocation carried out during the network window of the beacon interval as previously described with respect to FIG. 3. In one embodiment, the number of timeslots allocated may be random or may be optimized by an analysis of the transmission buffer or other information.

When the timeslot arrives, in step 360 the node performs a carrier sense operation to determine if there is traffic on the channel at the beginning of the timeslot. If the channel is not busy, as determined in step 365, then the node transmits data packets from the transmission buffer as illustrated in step 370. If the channel is busy, indicating that that another node in the network has the channel reserved, then the node holds its transmission and goes into a receive mode to receive any packets addressed to the node's MAC address.

FIG. 8 is a flow diagram illustrating an example process for distributed TDMA communication control according to an embodiment of the present invention. The example process may be carried out by a device such as the wireless communication device previously described with respect to FIGS. 2A and 2B. In the illustrated embodiment, the process initially begins at step 400 with the arrival of a new beacon interval. Upon the arrival of the new beacon interval, the node holds all data transmissions for the duration of the ATIM window.

Next, in step 410, the node performs beacon management. In one embodiment, beacon management includes the generation of a beacon frame, transmission of the beacon frame, reception and processing of a beacon frame, and time synchronization of the node's local clock according to the timestamp in the beacon frame. Generation of the beacon frame may be carried out by one or more nodes in the network. In one embodiment, a single node from each FCM generates and transmits a beacon frame. Upon reception of a beacon frame, the node parses the frame to identify beacon and network management information, including a timestamp. Once the timestamp is identified, the node can synchronize its local clock with the timestamp in order to facilitate accurate distributed TDMA communication with precisely agreed upon arrival times for timeslots and guard time periods. In one embodiment, the node may synchronize is local clock using the standard 802.11 TSF utility. Additionally, in one embodiment a FCM can be an independent basic service set (“IBSS”).

During the beacon management phase, the node will identify the end of the beacon window. When the beacon window has ended, as determined in step 415, the node then begins network and power management in step 420. The network management may include the allocation and adjustment of timeslots for the ensuing distributed TDMA window. Power management can also be implemented.

During the network management phase, the node will identify the end of the network window, and correspondingly the end of the ATIM window. When the ATIM window has ended, as determined in step 425, the node proceeds to the next distributed TDMA window during which data transmission proceeds, as shown in step 430.

FIG. 9 is a flow diagram illustrating an example process for synchronizing a local clock for distributed TDMA communication according to an embodiment of the present invention. The example process may be carried out by a device such as the wireless communication device previously described with respect to FIGS. 2A and 2B. In the illustrated embodiment, a node initially receives a beacon frame from another node in the wireless network, as shown in step 450. The beacon frame does not originate from a central controller device as in conventional TDMA communications. In one embodiment, the node only receives beacon frames from its neighbor nodes, for example by limiting the RF transmission range of beacon frames to only the neighbor nodes and by not forwarding beacon frames. In such an embodiment, synchronization only needs to be done locally and because communication interference is only significant to neighboring nodes within communication range, global synchronization is not necessary.

Next, after a node receives a beacon frame, it processes the frame to obtain beacon management and network management information. For example, the timestamp is parsed out of the beacon frame in step 455 and then the node synchronizes its local clock with the timestamp, as shown in step 460.

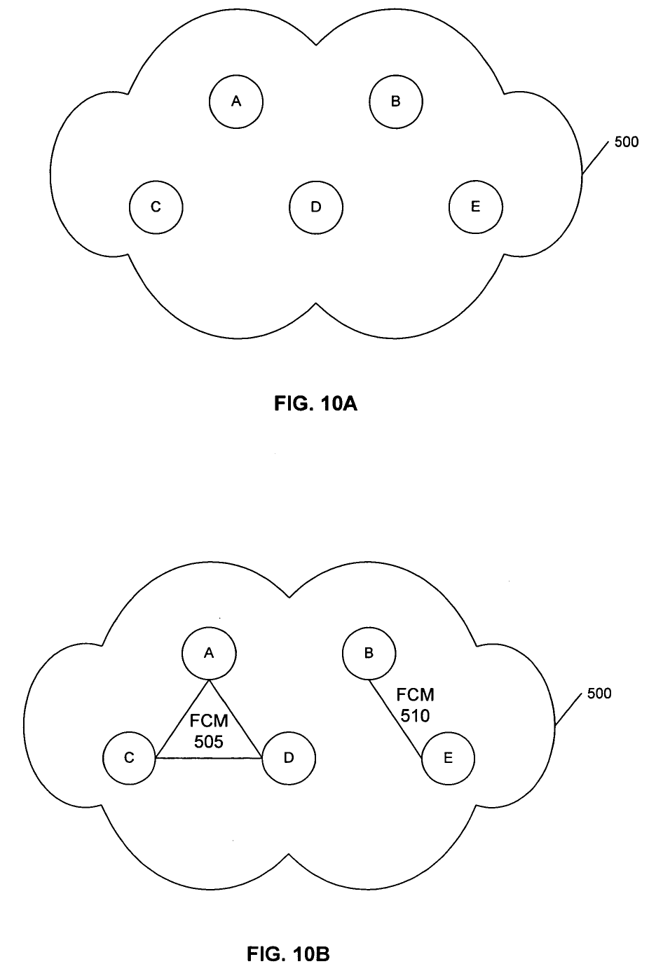

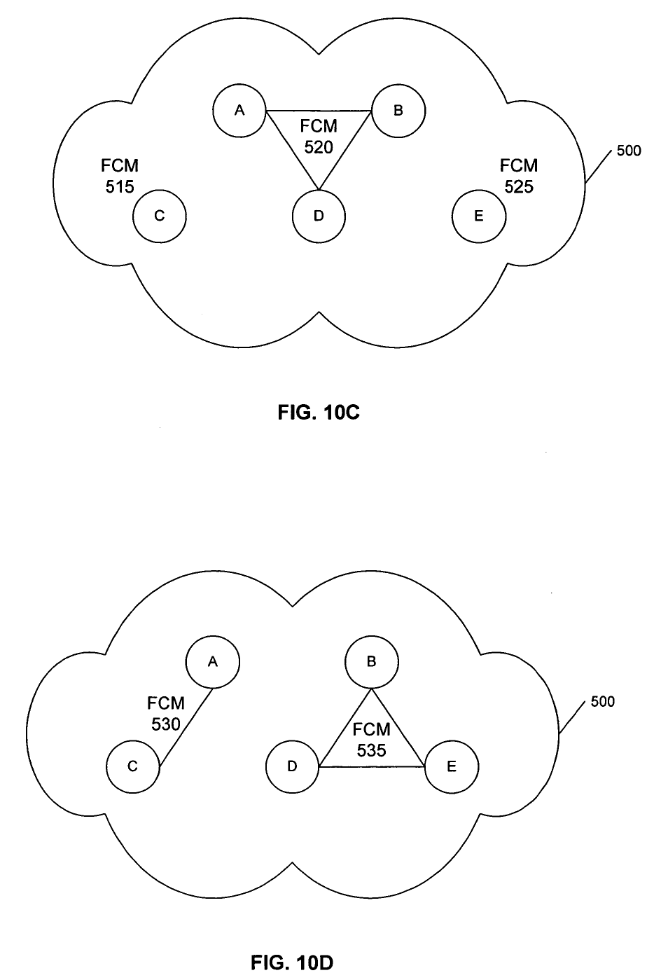

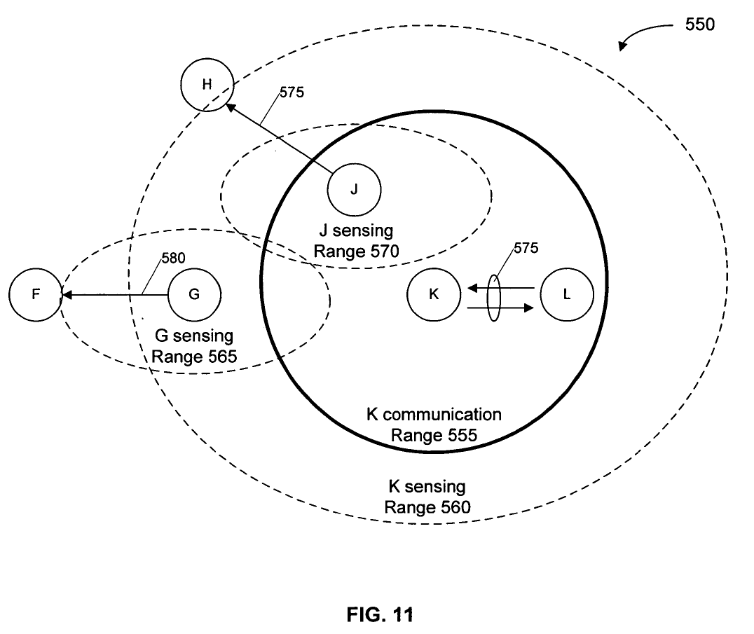

FIGS. 10A-D are network diagrams illustrating example self organizations of nodes in a wireless network 500 according to an embodiment of the present invention. Each node in the wireless network 500 may be a device such as the wireless communication device previously described with respect to FIGS. 2A and 2B. In the illustrated embodiments of FIGS. 10A-D, the network 500 comprises nodes A, B, C, D, and E and the nodes A-E are not all in direct communication with each other. For example, node E is not in direct communication with node A or node C. Similarly, node C is not in direct communication with node B.

Accordingly, depending on the timing of when the various nodes join the network 500, the self organization of the nodes in the network into various FCMs can take many forms. FIGS. 10B-10D are three alternative embodiments of self organizations that may be achieved, but one having skill in the art will understand that alternative self organizations are also possible.

In FIG. 10B, the nodes in the network 500 self organized into two FCMs. The first, FCM 505 comprises nodes A, C, and D. The second FCM 510 comprises nodes B and E. In this embodiment, the nodes may have self organized in this fashion by having nodes A and D initially appear identify the presence of each other. These two nodes may have initiated FCM 505. Next, node C may have appeared and because it is in direct communication with nodes A and D, node C was able to join FCM 505. The criteria for joining an FCM is that the new node be directly connected to each other node in the FCM. If the new node is not directly connected to each other node, then the new node may start its own FCM or join another FCM.

For example, in FIG. 10B if the next node to appear is node B, it could not join FCM 505 because it is not in direct communication with node C. Thus, it does not join FCM 505 and instead initiates FCM 510. When node E finally appears, it receives two beacon frames, one from FCM 505 and one from FCM 510. Because node E is not directly connected to nodes A and C, it does not join FCM 505 and instead joins FCM 510 with node B and maintains the fully connected mesh.

The configuration in FIG. 10C may have derived from the initial appearance of node C and the initiation of FCM 515. Next, node B may have appeared and initiated FCM 520 because nodes B and C are not in direct communication with each other. Then node D may have joined FCM 520 with node B and when node A appeared, it could have joined either FCM 520 or FCM 515. In this embodiment, node A joined FCM 520, perhaps because it received a beacon frame from a node in FCM 520 before receiving a beacon frame from node C. Finally, node E may have appeared and because it is not in direct communication with nodes A or C, it initiated its own fully connected FCM 525.

Similarly, the configuration in FIG. 10D may have derived from the initial appearance of node C and the initiation of FCM 530. Next, node B may have appeared and initiated FCM 535 because nodes B and C are not in direct communication with each other. Then node D may have joined FCM 535 with node B and when node A appeared, it could have joined either FCM 530 or FCM 535. In this embodiment, node A joined FCM 530, perhaps because it received a beacon frame from node C prior to receiving a beacon frame from a node in FCM 535. Finally, node E may have appeared and because it is in direct communication with nodes B and D, it joined FCM 535.

As should be clear from the various embodiments in FIGS. 10B-D, different organizations can be arrived at by the nodes in a network depending upon the timing and sequence of the self-organization process. Advantageously, any particular self organization will provide sufficient topological information to neighboring nodes such that effective distributed TDMA communication and directional carrier sense may be implemented.

FIG. 11 is a network diagram illustrating an example directional carrier sense communication in a wireless network 550 according to an embodiment of the present invention. In the illustrated embodiment, nodes F, G, H, J, K, and L comprise the wireless network 550. Node G has sensing range 565 and is capable of sensing (not receiving) transmissions from nodes K and L, among others. Node J has sensing range 570 and is capable of sensing and receiving transmissions from nodes K and L, among others. Node K has sensing range 560 and is capable of sensing transmissions from all nodes F, G, H, J, and L. Node K also has communication range 555 and is capable of sending one hop transmissions to nodes J and L.

Additionally show is node J transmission 575 to node H and node G transmission 580 to node F. Nodes K and L are alternatively transmitting and receiving in communication 585.

In a conventional 802.11 wireless communication network, when K and L are actively involved in communication 585, because the nodes G and J can sense the transmissions from nodes K and L, they are prohibited from sending their transmissions 580 and 575, respectively. They are prevented from sending their transmissions in order to avoid a possible collision. This overcautious limitation on conventional 802.11 communications severely limits overall communication bandwidth.

In an embodiment of the present invention, directional carrier sense is employed by the nodes in the network 550 in order to allow node G to send its transmission 580 even while nodes K and L are actively involved in communication 585. This is achieved by propagating information about the organization of the network such that node G knows that its transmission to node F will not cause a collision because nodes K and L are outside of the communication range of node G and because nodes G and F are outside of the communication range of nodes K and L.

In the illustrated embodiment, this information is known based on the FCM that each node has joined and the number of hops required to reach other nodes in the network 550. For example, if the number of hops to reach another node is greater than one, then the transmitting node knows that its transmission will not directly interfere with a transmission from the other node. As long as the separate transmissions are not directed to the same recipient node, then both node can transmit at the same time on the same channel. Application of directional carrier sense is extremely advantageous and is particularly useful where the sensing range of a node is much broader than the communication range of the node, which is usually the case.

Realizing all the distributed TDMA and directional carrier sense, along with any other enhancements for enhanced multihop data throughput may benefit from a method for designing a communication system across multiple protocol layer boundaries, in particular routing, link and physical layers, in a SDR. By implementing a large part of the MAC and physical layer protocols in SDR software instead of in firmware on board a radio frequency (“RF”) interface hardware unit or field programmable gate array (“FPGA”), the system has direct access to and control of all layers of protocol data structures and performance registers in SDR software. A cross-layer protocol design can thereby be realized effectively and efficiently.

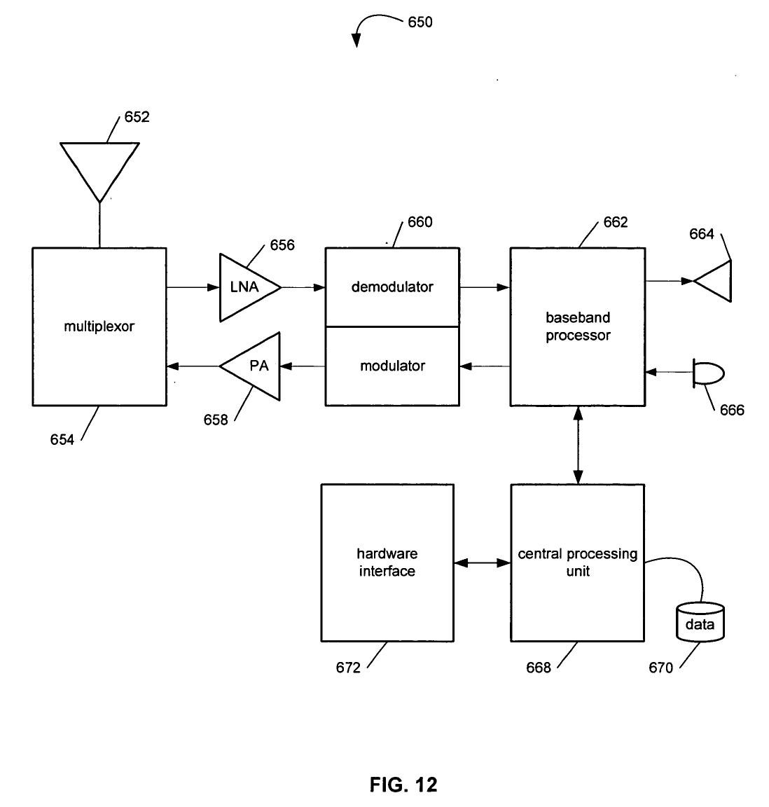

FIG. 12 is a block diagram illustrating an exemplary wireless communication device 650 that may be used in connection with the various embodiments described herein. For example, the wireless communication device 650 may be used in conjunction with a wireless communication device 50 as previously described with respect to FIGS. 2A and 2B. However, other wireless communication devices and/or architectures may also be used, as will be clear to those skilled in the art. For example, the wireless communication device 650 may be modified or optimized for voice communication or data communication, or both. The wireless communication device 650 may be a stand alone device or integrated into another device such as a personal digital assistant (“PDA”), a laptop computer or other computing device, a sensor, or any other type of device to which it is desirable to enable communication.

In the illustrated embodiment, wireless communication device 650 comprises an antenna 652, a multiplexor 654, a low noise amplifier (“LNA”) 656, a power amplifier (“PA”) 658, a modulation circuit 660, a baseband processor 662, a speaker 664, a microphone 666, a central processing unit (“CPU”) 668, a data storage area 670, and a hardware interface 672. In the wireless communication device 650, radio frequency RF signals are transmitted and received by antenna 652. Multiplexor 654 acts as a switch, coupling antenna 652 between the transmit and receive signal paths. In the receive path, received RF signals are coupled from a multiplexor 654 to LNA 656. LNA 656 amplifies the received RF signal and couples the amplified signal to a demodulation portion of the modulation circuit 660.

Typically modulation circuit 660 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 662.

If the base-band receive audio signal contains audio information, then base-band processor 662 decodes the signal and converts it to an analog signal. Then the signal is amplified and sent to the speaker 664. The base-band processor 662 also receives analog audio signals from the microphone 666. These analog audio signals are converted to digital signals and encoded by the base-band processor 662. The base-band processor 662 also codes the digital signals for transmission and generates a base-band transmit audio signal that is routed to the modulator portion of modulation circuit 660. The modulator mixes the base-band transmit audio signal with an RF carrier signal generating an RF transmit signal that is routed to the power amplifier 658. The power amplifier 658 amplifies the RF transmit signal and routes it to the multiplexor 654 where the signal is switched to the antenna port for transmission by antenna 652.

The baseband processor 662 is also communicatively coupled with the central processing unit 668. The central processing unit 668 has access to a data storage area 670. The central processing unit 668 is preferably configured to execute instructions (i.e., computer programs or software modules) that can be stored in the data storage area 670. Computer programs or software modules can also be received from the baseband processor 662 and stored in the data storage area 670 or executed upon receipt. Such computer programs, when executed, enable the wireless communication device 650 to perform the various functions of the present invention as previously described.

In this description, the term “computer readable medium” is used to refer to any media used to provide executable instructions (e.g., software and computer programs) to the wireless communication device 650 for execution by the central processing unit 668. Examples of these media include the data storage area 670, microphone 666 (via the baseband processor 662), antenna 652 (also via the baseband processor 662), and hardware interface 672. These computer readable mediums are means for providing executable code, programming instructions, and software to the wireless communication device 650. The executable code, programming instructions, and software, when executed by the central processing unit 668, preferably cause the central processing unit 668 to perform the inventive features and functions previously described herein.

The central processing unit is also preferably configured to receive notifications from the hardware interface 672 when new devices are detected by the hardware interface. Hardware interface 672 can be a combination electromechanical detector with controlling software that communicates with the CPU 668 and interacts with new devices.

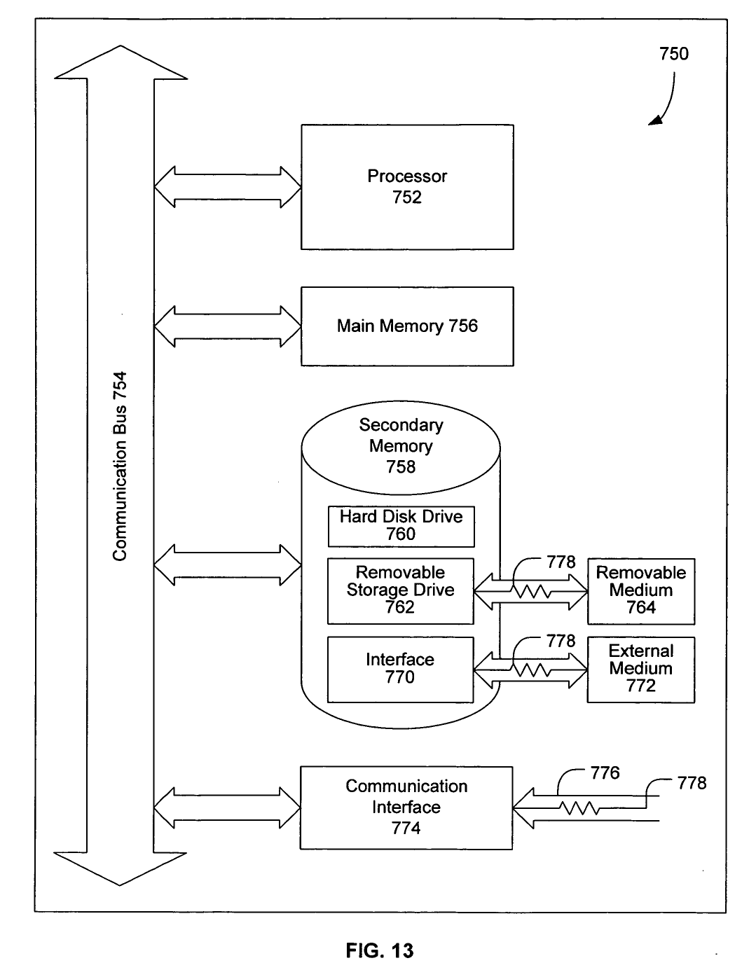

FIG. 13 is a block diagram illustrating an exemplary computer system 750 that may be used in connection with the various embodiments described herein. For example, the computer system 750 may be used in conjunction with a device 50 as previously described with respect to FIGS. 2A and 2B. The exemplary computer system 750 may also be combined with the wireless communication device 650 previously described with respect to FIG. 9. As will be understood by those having skill in the art, other computer systems and/or architectures may be used to facilitate wired or wireless communication by a computing device such as the exemplary computer system 750.

The computer system 750 preferably includes one or more processors, such as processor 752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 752.

The processor 752 is preferably connected to a communication bus 754. The communication bus 754 may include a data channel for facilitating information transfer between storage and other peripheral components of the computer system 750. The communication bus 754 further may provide a set of signals used for communication with the processor 752, including a data bus, address bus, and control bus (not shown). The communication bus 754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 750 preferably includes a main memory 756 and may also include a secondary memory 758. The main memory 756 provides storage of instructions and data for programs executing on the processor 752. The main memory 756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 758 may optionally include a hard disk drive 760 and/or a removable storage drive 762, for example a floppy disk drive, a magnetic tape drive, a compact disc (“CD”) drive, a digital versatile disc (“DVD”) drive, a multi-media card (“MMC”) or other solid state storage device, etc. The removable storage drive 762 reads from and/or writes to a removable storage medium 764 in a well-known manner. Removable storage medium 764 may be, for example, a floppy disk, magnetic tape, CD, DVD, etc.

The removable storage medium 764 is preferably a computer readable medium having stored thereon computer executable code (i.e., software) and/or data. The computer software or data stored on the removable storage medium 764 is read into the computer system 750 as electrical communication signals 778.

In alternative embodiments, secondary memory 758 may include other similar means for allowing computer programs or other data or instructions to be loaded into the computer system 750. Such means may include, for example, an external storage medium 772 and an interface 770. Examples of external storage medium 772 may include an external hard disk drive or an external optical drive, or and external magneto-optical drive.

Other examples of secondary memory 758 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 772 and interfaces 770, which allow software and data to be transferred from the removable storage unit 772 to the computer system 750.

Computer system 750 may also include a communication interface 774. The communication interface 774 allows software and data to be transferred between computer system 750 and external devices (e.g. printers), networks, or information sources. For example, computer software or executable code may be transferred to computer system 750 from a network server via communication interface 774. Examples of communication interface 774 include a modem, a network interface card (“NIC”), a communications port, a PCMCIA slot and card, an infrared interface, and an IEEE 1394 fire-wire, just to name a few.

Communication interface 774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 774 are generally in the form of electrical communication signals 778. These signals 778 are preferably provided to communication interface 774 via a communication channel 776. Communication channel 776 carries signals 778 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 756 and/or the secondary memory 758. Computer programs can also be received via communication interface 774 and stored in the main memory 756 and/or the secondary memory 758. Such computer programs, when executed, enable the computer system 750 to perform the various functions of the present invention as previously described.

In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Various embodiments may also be implemented primarily in hardware using, for example, components such as application specific integrated circuits (“ASICs”), or FPGAs. Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A system for distributed time division multiple access communication in an ad hoc wireless communication network, the system comprising:
a plurality of wireless communication devices configured for wireless communication in an ad hoc wireless communication network;
a beacon frame repeatedly transmitted over the ad hoc wireless communication network by the plurality of wireless communication devices;
wherein each of the plurality of wireless communication devices receives the beacon frame and synchronizes a clock with a timestamp in the beacon frame; and
wherein each of the plurality of wireless communication devices is configured to reserve one or more timeslots for transmitting data to implement distributed time division multiple access communications over the wireless ad hoc network.

2. A method for distributed time division multiple access between a plurality of nodes in a wireless mesh network, comprising:
receiving a beacon signal from a node in a wireless mesh network;
parsing the beacon signal to identify a timestamp;
adjusting a local clock based on the timestamp to synchronize with the plurality of nodes in the wireless mesh network;
initializing a first time slot for data communication; and
reserving the first time slot for data communication.

3. The method of claim 2, wherein reserving the first time slot comprises:
determining that the first time slot is idle; and
transmitting data during the first time slot.

4. The method of claim 3, wherein the determining step comprises performing a carrier sense operation when the first time slot arrives.

5. The method of claim 2, wherein the adjusting step further comprises executing the timing synchronization function specified by the IEEE 802.11 standard.

6. A wireless communication device configured to be communicatively coupled with one or more wireless communication devices to form a wireless mesh network, the wireless communication device comprising:
a programmed media access control (MAC) layer having a control communications module and a data communications module, the MAC layer configured to manage communications over the wireless network medium;
wherein the control communications module is configured to use a carrier sense multiple access procedure for control communications; and
wherein the data communications module is configured to use a time division multiple access procedure for data communications.

7. The wireless communication device of claim 6, further comprising communication hardware that conforms to the IEEE 802.11 standard.
